(19) United States
(12) Patent Application Publication
(10) Pub. No.: US 2021/0232702 A1
(43) Pub. Date: Jul. 29, 2021

(54) METHOD AND SYSTEM FOR DATA PRIVACY PROTECTION IN RELATIONAL DATABASES

(71) Applicant: Roy Moshe GELBARD, Tel Aviv (IL)

(72) Inventor: Roy Moshe GELBARD, Tel Aviv (IL)

(21) Appl. No.: 17/055,783

(22) PCT Filed: May 13, 2019
(86) PCT No.: PCT/IL2019/050535

§ 371 Date: Nov. 16, 2020

Related U.S. Application Data
(60) Provisional application No. 62/671,007, filed on May 14, 2018.

(51) Int. Cl. G06F 21/62; G06F 16/22; H04L 9/32

(52) U.S. Cl. CPC G06F 21/6245; H04L 9/3242; G06F 16/2282; G06F 21/6227

(57) ABSTRACT

A system and methods are provided for protecting private data items in a relational database, including: storing non-private attributes of entities of a first entity type in a first non-private table and storing one or more non-private attributes of entities of a second entity type in a second non-private table; and storing private attributes of entities of both the first and second entity types in a private table, wherein each record of the private table includes a single private-attribute field and a scrambled field, wherein the scrambled field is a transformation of an entity type field, a record identifier field, and an attribute identifier field, wherein the entity type field identifies an entity type of the given entity, the record identifier field identifies a corresponding record of a non-private table, and the attribute identifier field indicates an identifier of the private attribute whose value is stored in the private-attribute field.

### CROSS REFERENCES TO RELATED APPLICATIONS

This application is a national phase entry of International Patent Application No. PCT II L2019/050535, filed May 13, 2019, which claims the benefit under 35 U.S.C. § 119(b) to U.S. Provisional Patent Application No. 62/671,007, filed May 14, 2018, the entire contents of which are hereby incorporated by reference.

### FIELD OF THE INVENTION

The present invention relates to systems and methods for data protection in general and for data privacy protection in relational databases in particular.

### BACKGROUND

Data privacy is a major concern, as companies and institutions maintain data about customers and employees that must by law be protected and which, if obtained by others, could cause significant economic and/or social damage. Such data frequently includes personal identification information and banking information, such as credit card numbers.

Common data protection methods include restricting access to data with authentication methods including passwords, as well as with firewalls and secure VPNs. Data is frequently encrypted so that in the case that an unauthorized person gets access to a data file or database, the data must still be decrypted before it can be exploited. Nevertheless, such data schemes are vulnerable to security breaches caused by mismanagement or by insider theft on the part of data administrators. Further security methods and systems are warranted to overcome such threats.

### SUMMARY

It is an object of the present invention to provide systems and methods for protecting private and/or sensitive data.

There is therefore provided, by embodiments of the present invention, a computing system for protecting private attributes of multiple data entities stored in a relational database, the system including at least one processor and at least one memory communicatively coupled to the at least one processor, the memory including computer-readable instructions that when executed by the at least one processor cause the computing system to implement storing one or more non-private attributes of entities of a first entity type in a first non-private table and storing one or more non-private attributes of entities of a second entity type in a second non-private table. Each record of each of the first and the second non-private tables includes a record identifier field and at least one non-private attribute field, the non-private attribute field storing a value of one of the one or more non-private attributes of the respective entity. The computer-readable instructions, when executed by the at least one processor cause the computing system to further implement storing private attributes of entities of both the first and second entity types in a private table. Each record of the private table includes a single private-attribute field and a scrambled field, the single private-attribute field storing a value of a private attribute of a given entity, the scrambled field being a transformation of an entity type field, a record identifier field, and an attribute identifier field. The entity type field identifies an entity type of the given entity, the record identifier field identifies a corresponding record of a non-private table storing non-private attributes of the given entity, and the attribute identifier field indicates an identifier of the private attribute whose value is stored in the private-attribute field.

In some embodiments, the private table is physically separated from the first and second non-private tables. In further embodiments, the scrambled field is scrambled by a hash function. Access to the private table may be restricted by a security key mechanism.

In some embodiments, the entity type field may be identified as having the name of the associated non-private table.

There is also provided, by embodiments of the present invention, a method of protecting private attributes of multiple data entities stored in a relational database, implemented on at least one processor having at least one memory communicatively, the memory being coupled to the at least one processor and having computer-readable instructions that when executed by the at least one processor implement the method including: storing one or more non-private attributes of entities of a first entity type in a first non-private table and storing one or more non-private attributes of entities of a second entity type in a second non-private table, each record of each of the first and the second non-private tables including a record identifier field and at least one non-private attribute field, the non-private attribute field storing a value of one of the one or more non-private attributes of the respective entity; and storing private attributes of entities of both the first and second entity types in a private table, each record of the private table including a single private-attribute field and a scrambled field, the single private-attribute field storing a value of a private attribute of a given entity, the scrambled field being a transformation of an entity type field, a record identifier field, and an attribute identifier field, the entity type field identifying an entity type of the given entity, the record identifier field identifying a corresponding record of a non-private table storing non-private attributes of the given entity, and the attribute identifier field indicating an identifier of the private attribute whose value is stored in the private-attribute field.

### BRIEF DESCRIPTION OF DRAWINGS

For a better understanding of various embodiments of the invention and to show how the same may be carried into effect, structural details of the invention are shown to provide a fundamental understanding of the invention, the description, taken with the drawings, making apparent to those skilled in the art how the several forms of the invention may be embodied in practice. Reference will now be made, by way of example, to the accompanying drawings, in which:

FIGS. 1-3 show sets of data table definitions for relational databases, for improving data privacy protection, in accordance with some embodiments of the present invention; and

FIG. 4 is a flow diagram, depicting a process of improving data privacy protection, according to some embodiments of the present invention.

### DETAILED DESCRIPTION

In May 2018, General Data Protection Regulation (GDPR) directives came into force in Europe, which require assessments in a variety of areas, including the area of database management, especially relational databases management. Assessments in this area focus on the concept of an “access key” in order to enable access to a database.

The present invention adds two additional protection layers for storing information: 1) physical separation of all data items defined as private (or sensitive) data, such that these data items are separated into separate tables that are preferably (but not necessarily) stored in a different physical location; and 2) use of an additional key, within the physical separated tables, to provide manual joining (using an SQL join clause) to ensure privacy protection for all stakeholders, preventing anyone with any database access, including the technical support personnel, such as the database administrator (DBA), from relating private data fields to non-private fields of data entities.

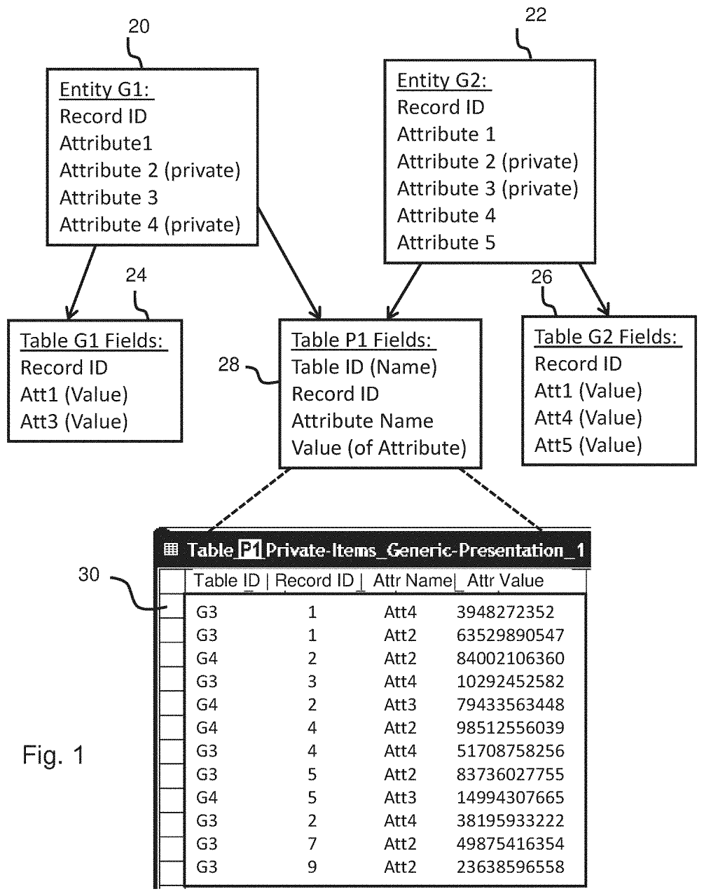

Reference is now made to FIG. 1, illustrating a solution for improving privacy protection, according to embodiments of the present invention. Schematic definitions 20 and 22 are shown for two types of data entities stored in a database, referred to respectively as G1 and G2. Entities typically have multiple attributes, and attributes may be designated as either private attributes or non-private (or “public”) attributes. Private attributes may require more security than non-private attributes because of legal requirements or because public exposure of the data could have harmful economic consequences.

In conventional, currently available systems, extra protection for private attributes may be achieved by designating, for a relational database, that the G1 and G2 entities are stored as records in respective tables, in which private fields of each record are stored in an encrypted format. However, an illicit hacker may gain access to database encryption keys and then upon gaining access to the respective tables, will have access to all private and non-private data.

In embodiments of the present invention, extra security protection is implemented by storing private attributes of both tables in a secure table P1. Values of non-private attributes of G1 entities are stored in records of a table G1 (indicated in the figure with schematic definitions 24). Values of non-private attributes of G2 entities are stored in records of table G2 (schematic definitions 26). Values of private attributes of both G1 and G2 entities are stored in records of a secure table P1 (schematic definitions 28), which is distinct from tables G1 and G2. Secure table P1 is preferably separated physically from tables G1 and G2.

All non-private attributes of a given entity are stored together in a single corresponding record in the entity's respective non-private attribute table. That is, non-private attributes of a G1 entity are stored as fields of a single record in table G1; non-private attributes of a G2 entity are stored as fields of a single record in table G2. As indicated in the figure, the fields of table G1 are: a record ID, the non-private attribute 1, and the non-private attribute 3. The fields of table G2 are: a record ID, the non-private attribute 1, the non-private attribute 4, and the non-private attribute 5.

Each record of table P1 stores one private attribute of an entity. Consequently, whereas an entity's non-private attributes are all stored together, an entity having multiple private attributes will have multiple corresponding records in table P1. The fields of table P1 are as follows. A table ID field of table P1 is an identifier representing the type of the entity, e.g., G1 or G2, or the name of associated table for the entity's non-private attributes, e.g., table G1 or G2. A record ID field of table P1 associates the private attribute of the given entity with the record ID of the corresponding record of non-private attributes of the same entity (stored in either G1 or G2). An attribute (or field) identifier, specifies the name of the private attribute. A value field stores the value of the indicated private attribute. Below the schematic table definition is a sample layout 30 of sample records of table P1. As indicated, values in the table ID field are either G1 or G2. (As described above, the table ID field values could also be specified by the entity names, G1 and G2, or by any other indicator associated with these entities.) Each entity added to the G1 or G2 tables is assigned a record ID, which is indicated in the record ID field of table P1. The field ID, or attribute ID, of table P1 indicates either attribute 2 or attribute 4 of G1 entities stored in table G1, or attribute 2 or attribute 3 of G2 entities stored in table G2. Values of private attributes are stored in the value field of table P1.

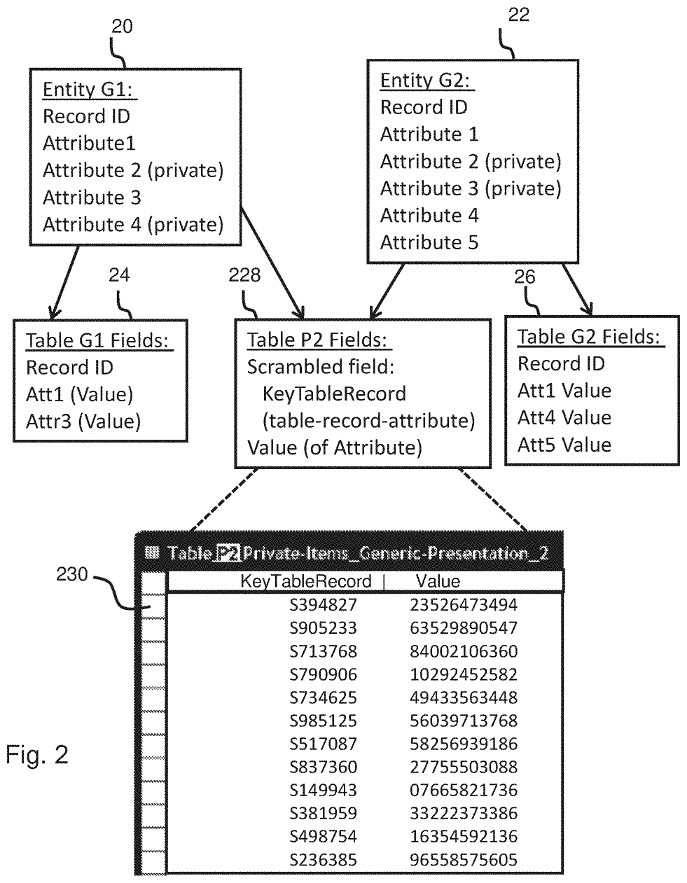

Reference is now made to FIG. 2 illustrating a refinement of the privacy protection of FIG. 1. Gaining access to table P1, an unauthorized user would be able to obtain private information by associating the table, record, and attribute fields to tables G1 and G2. FIG. 2 depicts an alternative schematic definition 228 of a private attribute table P2. Table P2 is a modified form of P1, based on the same entities and non-private attribute tables as those shown in FIG. 1. Like the table P1, the P2 table has a single record for each stored attribute record, with one field being a value field, storing the value of the indicated attribute. However, instead of the three separate fields for table, record ID and attribute identifier, the P2 table has a single field (indicated as “KeyTableRecord”), which merges the three fields in a scrambled format. The scrambling prevents visual identification. Scrambling may be accomplished by any known, reversible method of merging and encrypting multiple terms. A reversible hash function may, for example, be applied.

When stored in the format of table P2, the values of private attributes cannot be directly associated with any entity. That is, anybody gaining illegitimate access to table P2 sees lists of scrambled keys and attribute values (as indicated by the tabular sample 230), but cannot extract any associations that would give the data meaning. Moreover, because private attributes collected from multiple types of entities are stored in the same table, the values of the private attributes cannot even be associated with a type of entity (assuming that the data is of the same type, for example, numeric). Thus, an unauthorized/illegitimate user gaining access to table P2 would need to know the following information to obtain the full record information for an entity: how to unscramble the fields indicating the relevant entity (i.e., table, record, attribute); which private attribute tables exist (e.g., knowledge of the existence of P2); and how to access these additional tables.

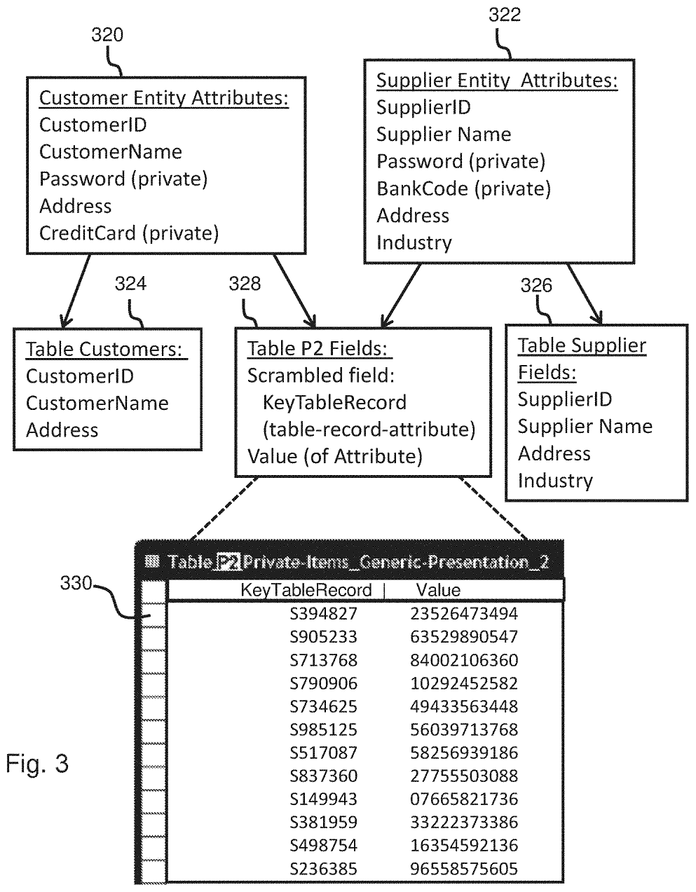

FIG. 3 shows that the data entities may, for example, represent respective customer data entities 320 and supplier data entities 322, which may be stored in a corporate enterprise resource planning (ERP) system, typically in tables of a relational database. For example, customer entities acquired and stored by the ERP system may have four attributes that are a name field, a password field, an address field, and a credit card field. Similarly, attributes of the supplier entities could be: a name field, a password field, a bank account field, and address field, and an industry type field. As indicated in the figure, the password and credit card attributes of the customer entities and the password and bank account fields of the supplier entities are private. Consequently, these records are stored in a table that is separate from tables for storing non-private attributes. The non-private attributes of the customer entities are stored in a customers table 324. The non-private attributes of the supplier entities are stored in a suppliers table 326. Records of the customers table may have three fields for the given example, a customer ID field, a customer name field, and an address field. Records of the suppliers table may have four fields for the given example, a supplier ID field, a supplier name field, an address field, and an industry type field. Private fields of both types of entities are stored in a private table P2 (328). Note that the fields of table P2 are the same for the particular case shown in FIG. 3 as they are for the generic case of FIG. 2. That is, the fields are a scrambled KeyTableRecord field and a value field. An example of a P2 table with stored values is indicated in the figure as table 330.

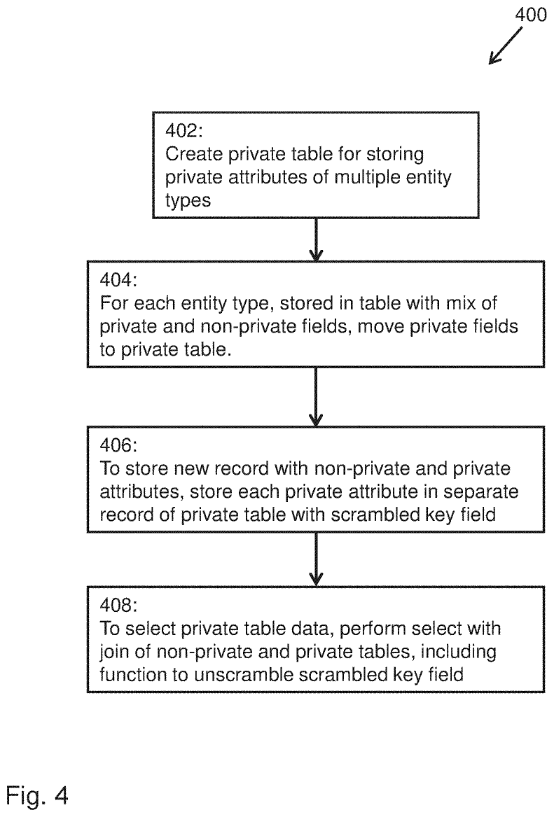

FIG. 4 is a flow diagram, depicting a process 400 of improving data privacy protection, according to some embodiments of the present invention. A computer system includes a processor and a memory having instructions to implement the process depicted. At an initial step 402, a private table is created for storing private attributes of multiple entity types. Each record of the private table includes a single private-attribute field and a scrambled field. The single private-attribute field stores one private attribute of a given entity; multiple private attributes of a given entity are stored in multiple respective records. The scrambled field is generating by merging the following identifiers: the entity type, the attribute identifier, and a record identifier (ID), where the record identifier field identifies a corresponding record of a non-private table storing non-private attributes of the given entity.

If an existing database is to be converted by the methods disclosed herein, then for tables of entities that store both non-private and private attributes, the private attributes are deleted from the existing tables, and records are created in the private attribute for each private attribute of each entity (step 404). Each record is stored with a private-attribute field, storing an attribute value, and with a scrambled identifier field, as described above. To add a new entity type to the database, assuming the entity type has both non-private and private attributes, a non-private table is created for storing each entity's one or more non-private attributes.

The records of non-private tables include a record identifier field and at least one non-private attribute field, such that each entity's non-private attributes are stored as non-private attribute fields of an entity record. To add a new entity to the database, assuming the entity has both non-private and private attributes, a non-private record is created in the non-private table for the entity type, and the entity's one or more non-private attributes are stored in the fields of the non-private record. In the same store transaction, private attributes are stored as separate records of the private attribute table of the database, each record storing an attribute value field and a scrambled identifier field (step 406).

The transformation of the entity type, the attribute identifier, and the record ID into a scrambled value is performed by a reversible process, such that extraction of data may be implemented with a select command having a join operator and applying the reversible encryption or hash function (step 408).

Using the example described above with respect to FIG. 3, which includes a customer entity, the following insert commands would be applied to add a new customer record to the database. The private data table is referred to, as above, as P2. Note that each private field is inserted separately and requires a hash, or encryption function:

INSERT INTO Customers (CustomerID, CustomerName, Address)

VALUES (‘123456789’, ‘Steve Smith’, ‘46 Herzl Rd., Jaffa”);

INSERT INTO P2 (KeyTableRecordField, Value)

VALUES (Private_Data_Hash(Customers, 123456789, Password),
‘23526473494’);

INSERT INTO P2 (KeyTableRecordField, Value)

VALUES (Private_Data_Hash(Customers, 123456789, CreditCard),
‘39482723523’);

A select command to extract information, such as a customer's credit card with respect to a customer entity requires a reverse decryption or unhash function, as follows (using a pseudo query command):

SELECT Customers.CustomerID, Customers.CustomerName, P2.Value

FROM Customers
JOIN P2
Where P2.Private_Data_Unhash(KeyTableRecordField,2) =

Customers.CustomerID AND
P2.Private_Data_Unhash(KeyTableRecordField,3) =
CreditCard;

The “hash” and “unhash” function may be have the following general format (encryption/hashing functions may include any known algorithms):

### Pseudo-Function to Scramble/Hash the Keys of Private Data:

Private_data_Hash ( Parameter1_table_id,

Parameter2_record_id,
Parameter3_att_name)

Returns Private_data_hash, data_type

begin /*function body: Encrypts the 3 parameters and returns the
encrypted string.

return Private_data_hash

end

### Pseudo-Function to Unscramble/Unhash the Keys of the Private Data in Order to Return the Record ID of the Relevant Record to the Relevant Table and Field:

Private_data_Unhash ( Parameter1_HashedCode,

Parameter2_ID_Request_to_Return)

Returns Private_data_Unhash, data_type

begin /* function body − Decrypts the input (= the hashed string), extracts

the 3 components: TableID, RecordID, FieldID. For example may
return the second component, Record-Id, which is in our case the
CustomerID.

return Private_data_Unhash

end

The parameter Parameter2_ID_Request_to_Return may refer to the second component of the three components obtained from the decryption function “Unhash,” that is, the customerID, which is the record ID of the three hashed values, these being the table name (Customers), the record_ID, and the attribute identifier.

Although the invention has been described in detail, nevertheless changes and modifications, which do not depart from the teachings of the present invention, will be evident to those skilled in the art. Such changes and modifications are deemed to come within the purview of the present invention and the appended claims.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, or via any appropriate communications means or combination of communications means. Each of the devices may comprise computers, such as those based on an Intel™ processor, that are adapted to communicate with the computer. Any number and type of machines may be in communication with the computer.

1. A computing system for protecting private attributes of multiple data entities stored in a relational database, comprising
at least one processor and at least one memory communicatively coupled to the at least one processor, the memory including computer-readable instructions that when executed by the at least one processor cause the computing system to implement steps comprising:
storing non-private attributes of a data entity in respective non-private attribute fields of a non-private record of a non-private table, wherein an entity type of the data entity is one of multiple entity types stored in the relational database, wherein the non-private table is one of multiple non-private tables identified according to corresponding entity types, and wherein each non-private record of each of the non-private tables includes a record identifier field and at least one non-private attribute field;
storing private attributes of the data entity in private attribute fields of private records of a private table, wherein each record of the private table includes a single private-attribute field and a key field, wherein the key field is a transformation of an entity type, a record identifier, and an attribute identifier, wherein the entity type identifies the non-private table storing the non-private attributes of the data entity, the record identifier identifies the non-private record storing the non-private attributes of the data entity, and the attribute identifier indicates a type of the private attribute is stored in the private attribute field; and
retrieving a private attribute of the data entity by performing a query including a join function of the private table and the non-private table storing the non-private attributes of the data entity, wherein retrieving the private attribute comprises retrieving a private record storing the private attribute, and wherein the key field of the retrieved private record is a transformation of the entity type of the data entity, of the record identifier of the data entity, and of an attribute type of the retrieved private attribute.

2. The computing system according to claim 1, wherein the private table is physically separated from the multiple non-private tables.

3. The computing system according to claim 1, wherein the key field is encrypted by a hash function.

4. The computing system according to claim 1, wherein access to the private table is restricted by a security key mechanism.

5. The computing system according to claim 1, wherein the entity type of the data entity corresponds to a name of the non-private table storing the data entity.

6-10. (canceled)

11. A computing method for protecting private attributes of multiple data entities stored in a relational database, comprising:
storing non-private attributes of a data entity in respective non-private attribute fields of a non-private record of a non-private table, wherein an entity type of the data entity is one of multiple entity types stored in the relational database, wherein the non-private table is one of multiple non-private tables identified according to corresponding entity types, and wherein each non-private record of each of the non-private tables includes a record identifier field and at least one non-private attribute field;
storing private attributes of the data entity in private attribute fields of private records of a private table, wherein each record of the private table includes a single private-attribute field and a key field, wherein the key field is a transformation of an entity type, a record identifier, and an attribute identifier, wherein the entity type identifies the non-private table storing the non-private attributes of the data entity, the record identifier identifies the non-private record storing the non-private attributes of the data entity, and the attribute identifier indicates a type of the private attribute stored in the private attribute field; and
retrieving a private attribute of the data entity by performing a query including a join function of the private table and the non-private table storing the non-private attributes of the data entity, wherein retrieving the private attribute comprises retrieving a private record storing the private attribute, and wherein the key field of the retrieved private record is a transformation of the entity type of the data entity, of the record identifier of the data entity, and of an attribute type of the retrieved private attribute.

12. The computing system according to claim 1, wherein the private table is physically separated from the multiple non-private tables.

13. The computing system according to claim 1, wherein the key field is encrypted by a hash function.

14. The computing system according to claim 1, wherein access to the private table is restricted by a security key mechanism.

15. The computing system according to claim 1, wherein the entity type of the data entity corresponds to a name of the non-private table storing the data entity.
